(19) United States
(12) Patent Application Publication
(10) Pub. No.: US 2007/0169387 A1
(43) Pub. Date: Jul. 26, 2007

(54) MULTIPLE MESSAGE AUDIO GIFT CARD HOLDER

(76) Inventor: Brett R. Glass, Overland Park, KS (US)

Correspondence Address: ERICKSON & KLEYPAS, L.L.C., 800 W. 47TH STREET, SUITE 401, KANSAS CITY, MO, 64112, US

(21) Appl. No.: 11/539,277

(22) Filed: Oct. 6, 2006

Related U.S. Application Data
(60) Provisional application No. 60/785,518, filed on Mar. 24, 2006.
(60) Provisional application No. 60/760,725, filed on Jan. 20, 2006.

(51) Int. Cl. G09F 1/00

(52) U.S. Cl. 40/124.03

(57) ABSTRACT

A device designed to hold a gift card that personalizes the gift to the recipient through the use of audio messages. The device contains a slot whereby a gift card can be inserted into the body of the holder. Artwork and various materials are used to enhance the exterior of the holder. An audio recording and playback feature is contained within the housing of the holder to allow audio information, such as a personal greeting, to be communicated to the intended recipient of the gift card. Other embodiments of the invention allow for the user to select among several pre-recorded audio segments by pressing a button corresponding to the selected audio segment.

### CROSS REFERENCE TO RELATED APPLICATION

This application claims the benefit of the prior filed, co-pending provisional applications, Ser. No. 60/758,518, filed Jan. 12, 2006 and Ser. No. 60/760,725, filed Jan. 20, 2006.

### BACKGROUND OF THE INVENTION

This invention relates generally to gift cards and more particularly to a device for holding and displaying gift cards while providing indicia and/or audio recordings selected or provided by the purchaser to personalize the gift.

Commercial transaction cards, or gift cards as they are commonly called based on their typical intended use, have become popular gifts. Gift cards comprised approximately 11% of the holiday expenditures for the 2005 holiday season. Most gift cards have a size and shape similar to that of credit cards and may use a similar magnetic strip technology to store data. While popular, gift cards are typically provided with a generic and impersonal design, typically identifying the associated merchant for which the card may be used to purchase merchandise, and therefore are not personalized in view of the intended recipient.

Devices for recording, storing and playing back audio have been associated with greeting cards and the like, such as is disclosed in U.S. Pat. Nos. 5,577,018, 5,652,606 and 6,845,583. The audio circuitry typically includes a speaker that also functions as a microphone when recording a message, a control circuit, a memory circuit or chip to provide random access memory for electronically storing sound recordings, one or more switches, batteries to provide power to the device, and associated wiring and mounting hardware.

What is needed is a gift card holder adapted to securely hold and display a generic gift card to thereby personalize the gift to the recipient, either through selection among gift card holders having pre-designed indicia or pre-recorded audio of interest or entertainment to the recipient, or through provision of audio recorded by, and/or indicia selected by, the gift giver.

### BRIEF DESCRIPTION OF THE INVENTION

An embodiment of the invention comprises a gift card holder including a housing that may bear indicia or decorations, a slot for inserting a gift card into the holder, a window for displaying the gift card, circuitry for recording and/or playing sound such as music and/or a message from the gift giver, a sound speaker, a power source such as one or more commonly available watch batteries, and record and playback buttons or switches. Typically, the holder is sold to the gift giving consumer secured within packaging including clear wrap, a cardboard backing board and a hang tag or label. The holder may be sold with the gift card pre-installed within the slot but more typically would be sold separately from the gift card so that any holder could be combined with any commonly sized gift card.

Other advantages of the invention will become apparent from the following description taken in connection with the accompanying drawings, wherein is set forth by way of illustration and example an embodiment of the present invention.

### BRIEF DESCRIPTION OF THE DRAWINGS

FIG. 1 is a perspective view of a gift card holder.

FIG. 2 is a perspective view of a gift card partially inserted into the gift card holder of FIG. 1.

FIG. 3 is an exploded, perspective view of the gift card holder of FIG. 1.

FIG. 4 is a perspective view of a gift card holder having a single button for initiating record and playback functions.

FIG. 5 is a perspective view of a gift card partially inserted into the gift card holder of FIG. 4.

FIG. 6 is an exploded, perspective view of the gift card holder of FIG. 4.

FIG. 7 is a perspective view of a gift card holder having multiple play buttons.

FIG. 8 is a perspective view of a gift card partially inserted into the gift card holder of FIG. 7.

FIG. 9 is an exploded, perspective view of the gift card holder of FIG. 7.

FIG. 10 is a perspective view of an alternative embodiment of a gift card holder fitted with feet to stand the holder in an upright position.

FIG. 11 is an exploded view of certain elements associated with the back housing of the gift card holder of FIG. 10.

FIG. 12 is a view of major electrical components of the gift card holder FIG. 10.

FIG. 13 is a schematic showing the interrelation of major electrical circuit components of a gift card holder having multiple pre-recorded audio segments or recordings.

FIG. 14 is a view of major electrical components of an alternative embodiment of a gift card holder.

FIG. 15 is a schematic showing the interrelation of major electrical circuit components of a gift card holder having record and play functions or modalities.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring now to FIGS. 1 through 3, a gift card holder 1 includes a housing 2 with a central opening 15 therethrough. The housing 2 includes a front housing 5 and a back housing 10, which are typically formed of molded plastic. The front housing 5 and back housing 10 are generally symmetrical to one another in overall size and shape and cooperate when attached to one another to form an enclosure. The opening 15 and the housings 5 and 10 cooperate to form a frame for receiving and holding a gift card 20. A gift card 20 typically bears unique indicia and/or magnetically recorded information that allows the bearer to make purchases against a determined cash balance associated with the card.

A slot 40 is provided in a side of the housing 2 allowing the gift card 20 to be slid between the front housing 5 and back housing 10 for display within the central opening 15. The housing may include retaining clips 45 that project inward from the front housing 5 and back housing 10 at the margins of the central opening 15 to further secure the gift card 20 when inserted into the holder 1.

The holder 1 includes an acoustic speaker 25 for recording and playing back sound and a record button 30 attached to digital recording circuitry 27 within the housing 2. When the record button 30 is pressed a user may record an audible message by speaking into the speaker 25. The holder 1 further includes a playback button 35, also attached to circuitry 27 within the housing 2, that when pressed causes the recorded message to be retrieved from digital memory and played over the speaker 25.

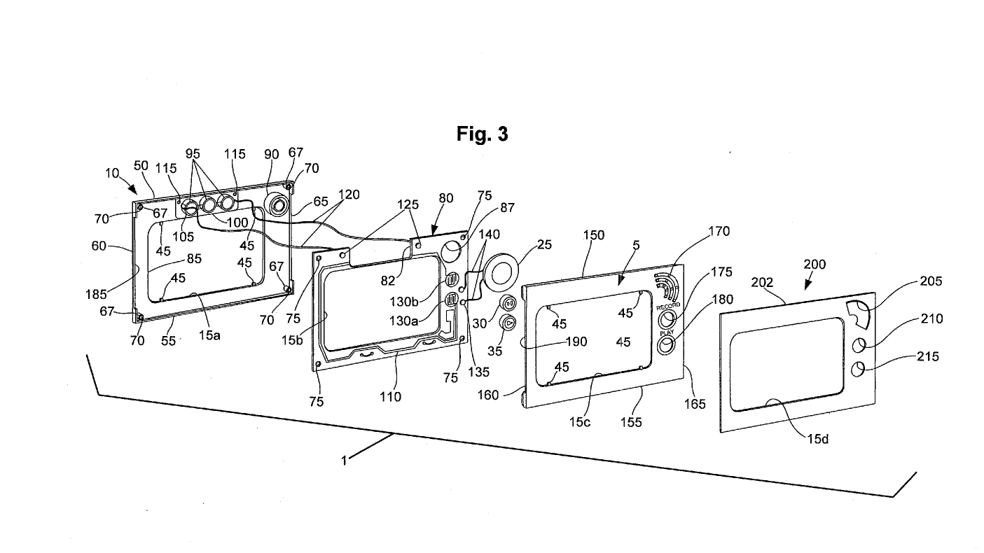

FIG. 3 illustrates the holder 1 in perspective view with major parts exploded from one another to show internal details and to indicate general assembly of the holder 1. Looking at the holder 1 in more detail and referring to FIG. 3, the back housing 10 comprises a relatively flat rectangular structure having generally elongated top and bottom sides 50 and 55, respectively, and relatively shorter left and right sides 60 and 65, respectively. Typically, the ratio of the length of the top 50 and bottom 55 sides to the left 60 and right 65 sides is similar to the ratio of the length of the longer sides of a gift card 20 to the shorter sides thereof.

The back housing 10 includes a central opening 15a which forms a rearward portion of the opening 15 in the housing 2. Retaining clips 45 project inward from the central opening 15a. The back housing 10 is provided with screw bosses 67 with screw holes 70 for receiving screws (not shown) passed through holes 75 in an associated circuit board 80 in order mount the circuit board 80 on the inward face 85 of the back housing 10. As illustrated, the screw bosses 67 project forward, and inward, from the face 85 of the back housing 10. A generally cylindrical speaker housing 90 also projects forward from the face 85 to receive the speaker 25 during assembly. The back housing 10 includes a battery retaining assembly 95 that is attached to a battery compartment door 100. Batteries 105, typically watch type batteries, are held within the battery retaining assembly 95 which typically comprises metal clips that connect one battery 105 to another in a manner appropriate to deliver the voltage and amperage required by the circuit 110. The battery compartment door 100 includes screw holes 115 for receiving screws (not shown) that are passed through the holes 115 from the back of the housing 10 and into screw receiving holes in bosses (not shown) projecting rearward from the front housing 5. Wires 120 run from the battery retaining assembly 95 to battery connection points 125 on the circuit board 80.

The circuit board 80 is generally rectangular with similar dimensions to the front 5 and back 10 housings, but of somewhat reduced size to fit within the housing 2. The circuit board 80 also has a central opening 15b. The central opening 15b is of similar dimensions to the openings 15a and 15c of the back 10 and front 5 housings, and may be of somewhat larger dimensions to ensure that the margins of the opening 15b are not readily viewed once the device 1 is assembled. The circuit board 80 is formed of materials commonly used for such purpose in the prior art, typically a thermally stable non-conductive material such as thermoset plastic or epoxy-fiberglass laminate. A notch 82 in the upper portion of the circuit board 80 provides space for the batteries 95 once the holder 1 is assembled. A relatively large hole 87 in the upper right portion of the circuit board 80 is provided to allow the rearward portion of the speaker to 25 to pass through the circuit board 80 to engage the speaker housing 90.

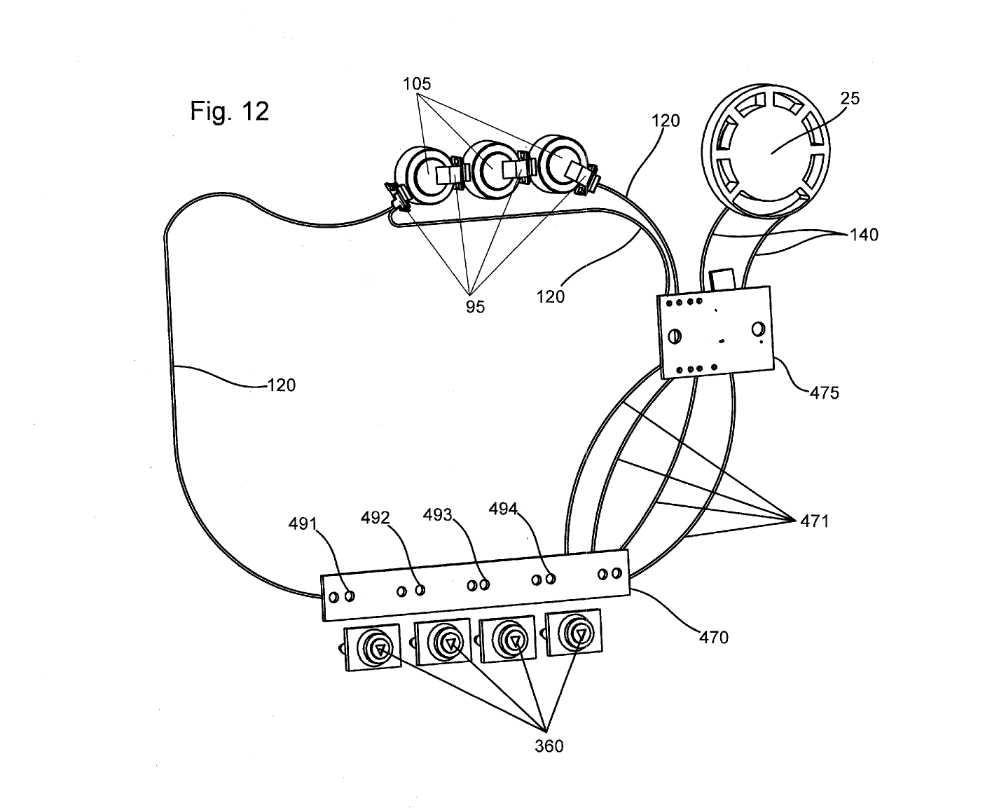

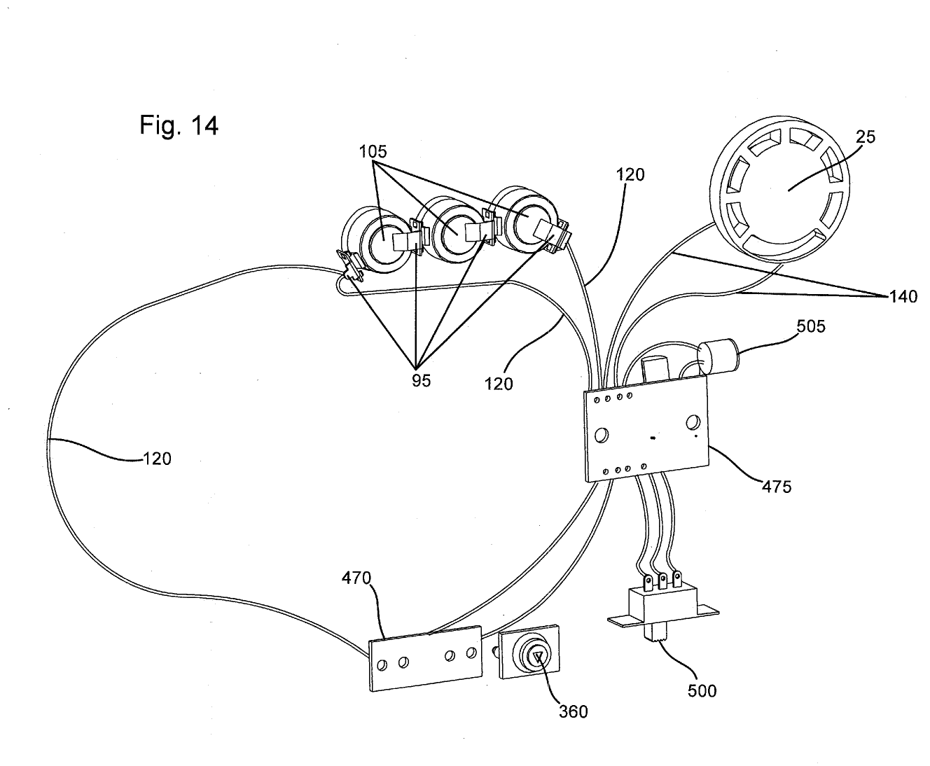

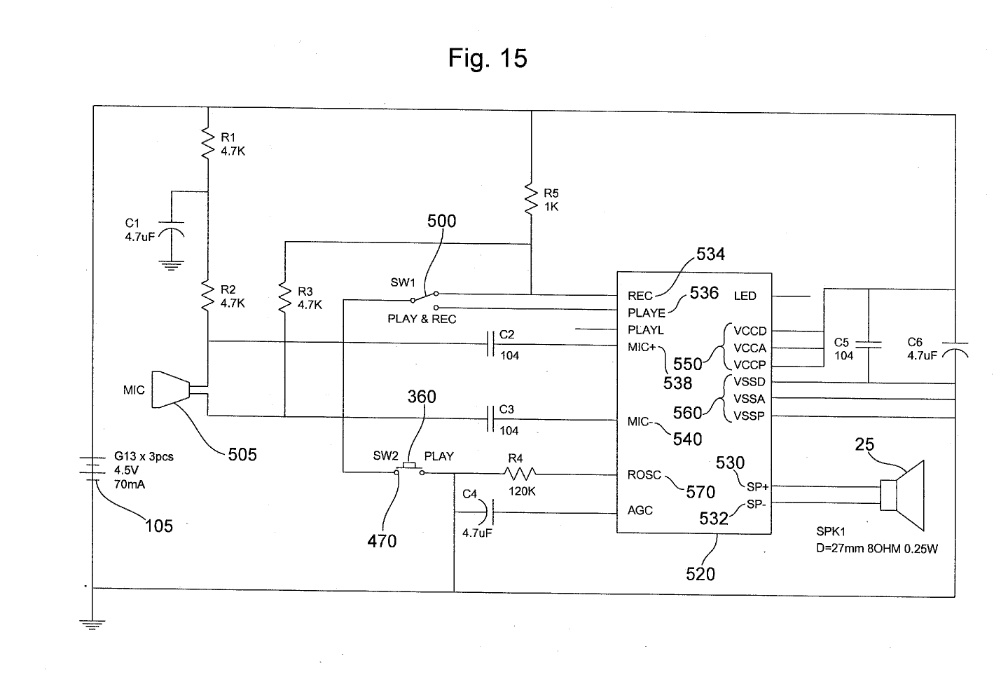

The digital recording circuit 110 is attached to the circuit board 80 and includes battery connections 125 and switch circuitry 130a and 130b associated with the playback and record buttons 35 and 30, respectively. The switch circuitry 130a and 130b typically includes pressure sensitive devices such as pressure sensitive switches. The circuit 110 also includes speaker attachment connections 135 for connection to electrical wires 140 projecting from the speaker 25. Typically, the wires 140 conduct electricity to a coil within the speaker 25. The circuit board 80 allows for the provision of the central opening 15b by disposing circuitry 110 near the periphery of the circuit board 80, between the margins of the central opening 15b and the outer edges of the circuit board 80. Other components (not shown in FIG. 3) of circuit 110 typically include a memory chip and a processor, which are typically located within an integrated circuit 520 (see FIG. 15) and/or upon a control board 475 (see FIGS. 12 and 14). The memory chip may include volatile random access memory (RAM), non-volatile memory such as Flash memory, or any other small, electronic memory component suitable for electrically storing recorded audio. An example of appropriate prior art circuitry of the type that may be adapted for use with this device 1 includes a digital recording unit sold by Radio Shack, part no. 276-1323.

The front housing 5 has a general shape similar to that of the back housing 10, including elongated top 150 and bottom 155 sides and relatively shorter left 160 and right 165 sides. A central opening 15c forms a forward part of the opening 15 and is typically of the same dimensions as the central opening 15a of the back housing 10. The front housing 5 includes gift card retaining clips 45 projecting inward from the margins of the central opening 15c. The retaining clips 45 of the front and back housings 5 and 10 are positioned so that each clip 45 on the back housing 10 is directly opposed by a corresponding, cooperating clip 45 on the front housing 5. Pairs of clips 45 cooperate to hold a gift card 20 securely within the holder 1 by applying light pressure against the card 20 when the card 20 is inserted into the housing 2 and between such cooperating pairs of clips 45.

Cooperating clips 45 form a functional pair and are positioned to one another such that the space or gap between the clips 45 is of a distance slightly smaller in dimension than the thickness of a typical gift card 20. When the gift card 20 is inserted into the housing 2, therefore, the cooperating pairs of clips 45 are slightly spread apart from one another by the interposition of the card 20. The clips 45, being formed of flexible, resilient material such as plastic, and typically molded contiguously with their associated housing 5 or 10, are able to flex outward to accommodate the card 20 but in doing so apply pressure against the card 20 sufficient to hold the card 20 in place within the holder 1.

A speaker opening or openings 170 extend through the front housing 5 to allow sound produced by the speaker 25 to be readily heard outside the housing 2. The front housing 5 also includes openings 175 and 180 for receiving the record and playback buttons 30 and 35 respectively. Labels proximate to the openings 175 and 180 identify the record and playback buttons as do indicia on the buttons 30 and 35.

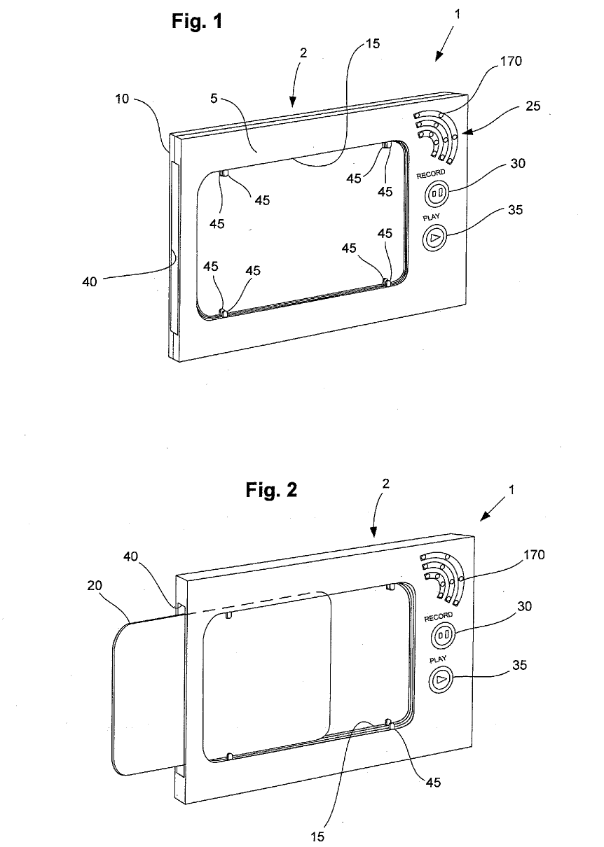

The front and back housings 5 and 10 have recessed portions or areas of relief 190 and 185 on the left sides 60 and 65, respectively, that form the gift card slot 40 when the front housing 5 and back housing 10 are attached to one another during assembly of the holder 1. The front 5 and back 10 housings may be provided with mechanical features, common in the art, to allow them to snap together securely, or are heat welded or joined to one another with adhesive. FIG. 2 illustrates a holder 1 wherein a gift card 20 is partially inserted into the slot 40 so that a portion of the gift card 20 is viewable within the central opening 15.

The holder 1 may include decorations, such as a decal 200 (see FIG. 3), that may be applied to either of the housings 5 or 10 by adhesion or other methods. The decoration 200 may include various materials such as artwork stickers, decorative plastic, vinyl, photographic artwork, plush material, feathers, mirror-like surfaces, glitter, metallic coating, faux fur, lenticular artwork, and/or holographic artwork. As illustrated, the decal 200 includes a generally rectangular body 202 having various apertures including a central opening 15d, a semicircular opening 205 adapted to surround the speaker opening 170, and holes 210 and 215 to allow the user to contact the record 30 and playback 35 buttons.

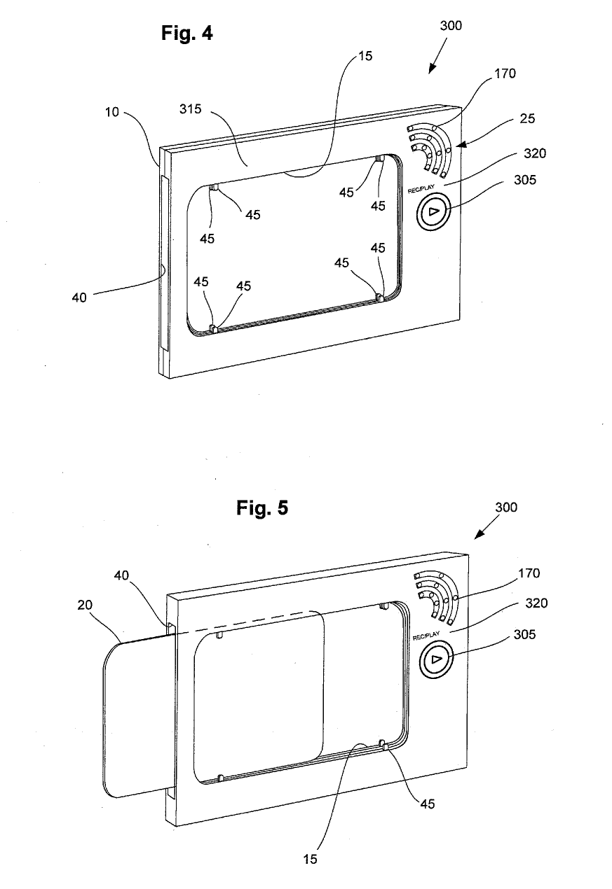

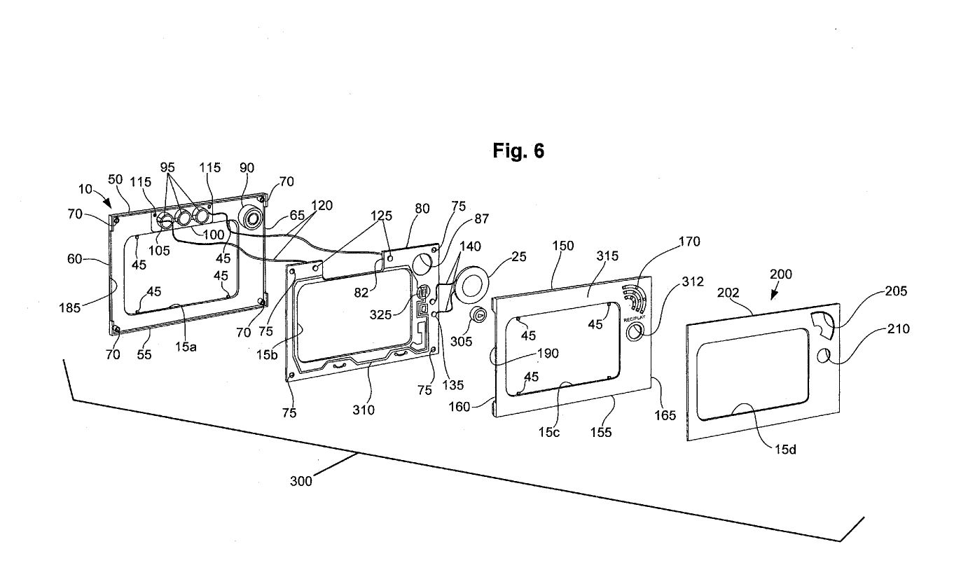

FIGS. 4 through 6 illustrate an alternative embodiment of the invention including a holder 300 having a single button 305 utilized for initiating both record and playback functions in appropriately modified circuitry 310. Elements having substantial structural commonality with those of the holder 1 illustrated in FIGS. 1 through 3 are identified using the same numbering as used in FIGS. 1 through 3. Elements that include notable changes in structure from that of the previously described holder 1 have been renumbered.

The record/playback button 305 of the holder 300 protrudes through an aperture 312 in the front housing 315. Typically, a label 320 indicating the functionality of the button 305 is provided on the front housing 315 in proximity to the button 305. Record/playback switch circuitry 325 typically includes a pressure sensitive device such as a pressure sensitive switch capable either mechanically, or through associated circuitry, to distinguish between a record mode and a playback mode. Typically, the playback mode is initiated by pressing the button 305 for a relatively short period of time (e.g. less than 2 seconds), the playback mode causing the circuitry 310 of the holder 300 to access recorded sound from memory and play such sound over the speaker 25. A record mode is typically initiated by pressing the button 305 for a period of time of longer duration than that associated with the playback mode (e.g. greater than 2 seconds), the record mode causing sound received by the speaker 25 to be read into memory by the circuitry 310. Alternatively, sound may be read into memory from a source other than the speaker, as may be case if storage of a pre-recorded message in memory is performed prior to commercial distribution of the holder 300. A decoration 200, such as a decal applied to the front housing 315, may be readily modified to omit one of the openings 210, 215 as only one opening is needed if only one button is used for both playback and record functions. For example, the record button opening 210, if properly positioned, may suffice to allow user access to the record/playback button 305.

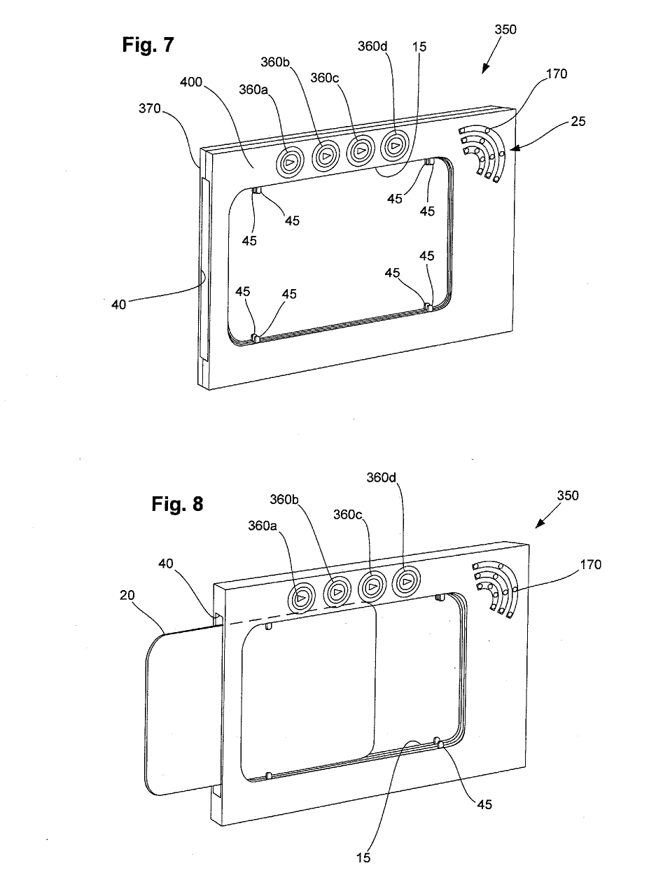

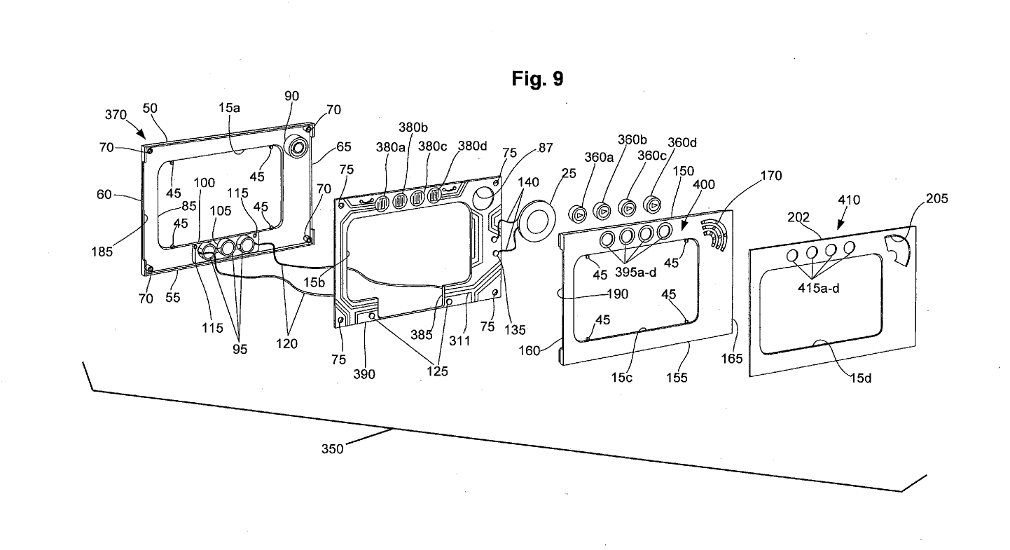

FIGS. 7 through 9 illustrate a further alternative embodiment of the invention including a holder 350 having a plurality of buttons 360a through 360d (referred to collectively by reference number 360) for initiating playback functions in appropriately modified circuitry 311 (see FIG. 9). Elements having substantial structural commonality with those of the holder 1 illustrated in FIGS. 1 through 3 are identified using the same numbering as is used in FIGS. 1 through 3. Elements that include notable changes in structure from that of the previously described holder 1 have been renumbered.

The holder 350 includes a back housing 370 that is substantially similar to the previously described back housing 10 with changes including positioning of the battery retaining assembly 95, battery compartment door 100, and batteries 105 proximate to the bottom side 55 of the holder 350 in order to provide room within the holder for the play buttons 360 and associated switch circuitry (switches) 380a through 380d. In order to accommodate the batteries 105, the notch 385 in the circuit board 390 is located in the lower portion of the circuit board. Openings 395a through 395d are provided in the front housing 400 to align with the buttons 360 and switches 380a through 380d. A decoration 410, such as a decal applied to the front housing 400 provides openings 415a through 415d to allow user access to the play buttons 360.

In use, the holder 350 is provided to the end user with multiple prerecorded sounds or messages stored in memory such that the user may selectively listen to a message by pressing the corresponding button 360. For example, a user pressing button 360a activates switch 380a causing a sound or message of predetermined duration to be retrieved from memory and played through the speaker 25. Pressing button 360b activates switch 380b causing another sound or message to be retrieved from memory and played. The messages corresponding to each button 360 may also correspond to images provided on the holder 350, such as those of popular characters.

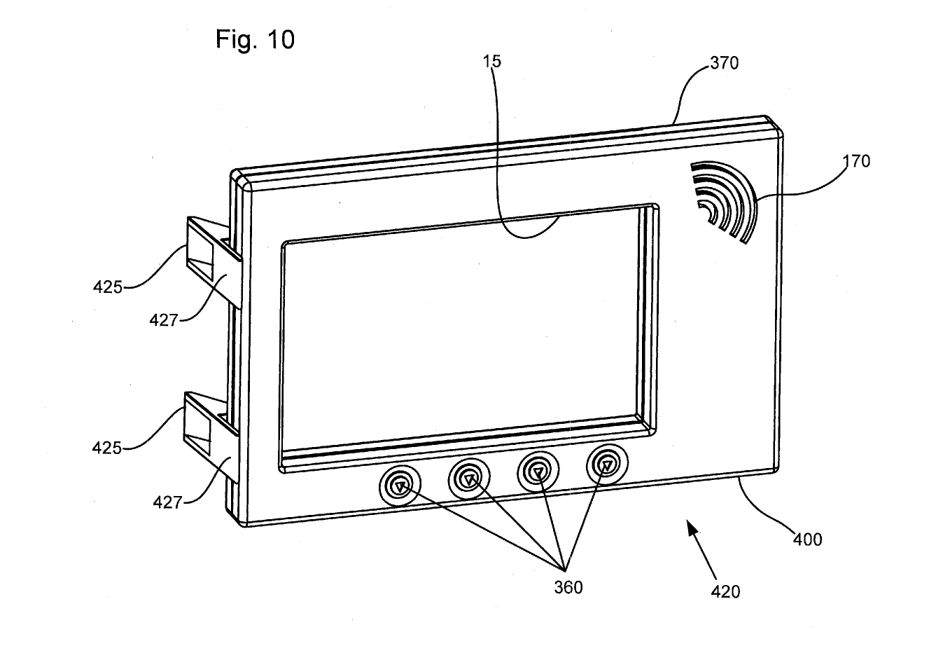

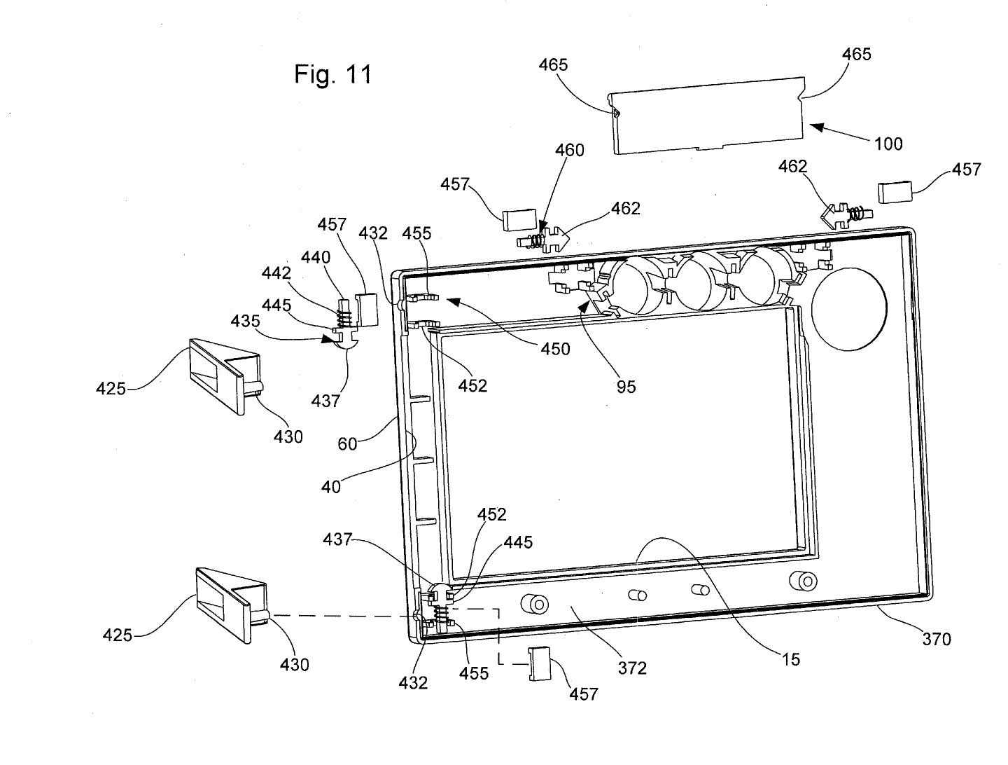

FIGS. 10 and 11 illustrate an embodiment of a gift card holder 420 similar to the holder 350 shown in FIGS. 7 through 9. In addition to the front housing 400, back housing 370, central opening 15, speaker openings 170, and buttons 360, the holder 420 includes legs or feet 425. The feet 425 may take a variety of shapes but typically include a relatively planar bottom surface 427 for supporting the holder 420 upon a support surface such as a table or desk (not shown) when the holder 420 is placed in an upright position upon the support surface. As shown in FIG. 11, posts 430 project from a surface of a foot 425 opposite to the bottom surface 427. The posts 430 are sized to fit snugly within holes 432 in an edge or side of the holder 420, which is shown as being the left side 60 but could also be the right side 65, bottom side 55, or top side 50. It should be appreciated that the holder 420 will typically be rotated so that the side that bears the feet 425 is facing downward to place the feet 425 against the support surface.

The holder 420 includes pressure clips 435 for retaining the card 20 within the slot 40. The pressure clips 435 include a head 437 for bearing against a surface to be held in a static position (such as a gift card 20), a shaft 440 extending from the head 437 for receiving a spring 442, and a stop flange 445 transverse to the shaft 440 for limiting travel of the clip 435 along the longitudinal axis of the shaft 440. The shaft 440 is received within a cradle 450 projecting from the inner face 372 of the back housing 370. A cradle 450 includes an inward arm 452 and an outward arm 455 that are sized and shaped to receive and hold the shaft 440. The inward arm 452 is adapted to hold the portion of the shaft 440 intermediate to the head 437 and stop flange 445 while allowing some movement of the shaft 440 relative to the arm 452. The outward arm 455 is adapted to hold the shaft 440 and associated spring 442 so that the spring 442 is disposed between the arms and may be compressed against the outward arm 455. Once a clip 435 is properly set within a cradle 450, a press plate 457 is snapped onto the cradle 450 to hold the clip 435 within the cradle 450, while still allowing the shaft 440 to move as described above.

When a gift card 20 is inserted into the slot 40, it presses lightly against the clips 435. The head 437 of each clip 435 is thereby pushed outward by the card 20, compressing the spring 442. The compressed spring 442 exerts a force upon the clip 435 causing the head 437 to press against the card 20, thereby increasing friction between the head 437 and the card 20 sufficient to hold the card 20 within the slot 40. In this manner, the card 20 may be removably, but securely, installed within the holder 420.

The door 100 is attached to the back housing 370 in a similar manner using clips 460 with pointed or arrow-shaped heads 462. When the door 100 is pressed into place within a similarly-sized aperture in the back housing 370, clips 460 frictionally and mechanically engage notches 465 in the door 100 such that the tips of the heads 462 fit into the similarly-sized notches 465. The door 100 is sized, shaped and positioned to cover a battery retaining assembly 95 within the holder 420.

FIG. 12 illustrates major electrical components of holder 420 including a button switch plate 470. The button switch plate 470 includes small switches 491, 492, 493, and 494, each one activated by its respectively associated button 360. A main control circuit board 475 receives inputs from the switch plate 470 via wires 471 and activates memory segments associated with the buttons 360. A memory chip and associated circuitry is mounted on the board 475. A speaker 25 is attached to the control board 475 via wires 140 for receiving electrical signals from a selected memory segment and converting the signals to sound. Batteries 105 held within a battery retaining assembly 95 provide electrical power via wires 120 to the aforementioned electrical components.

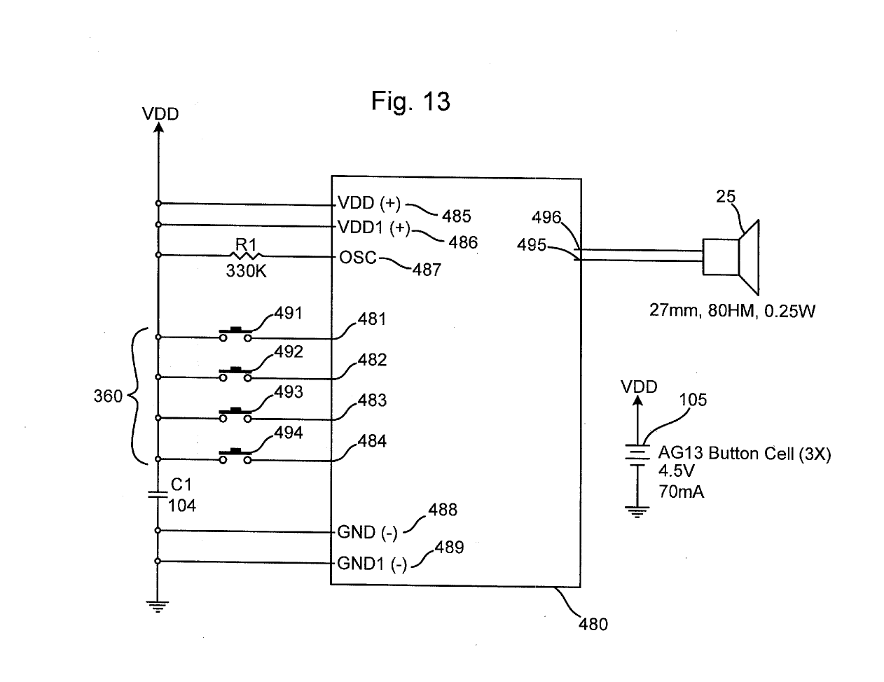

FIG. 13 is a diagrammatical schematic of the electrical components (circuitry or circuit 421) of holder 420 (see FIG. 12). In the present embodiment, the power source 105 for providing electrical power to the circuit 421 comprises three 1.5 volt button cell batteries arranged in series to deliver 4.5 volts (4.5V), 70 milliamperes (70 mA). A memory chip 480 for storing and accessing audio recordings (the memory chip 480 is mounted on the control board 475 shown in FIG. 12). FIG. 13 also shows switches 491, 492, 493, 494 for selecting audio playback from a particular memory storage segment within the chip 480, and a speaker 25 for converting electrical signals, delivered through memory chip output terminals 495 and 496, to audible sound waves. The memory chip 480 may comprise an integrated circuit (IC) with electronic memory storage segments and associated processing circuitry. IC 480 inputs 481, 482, 483, 484 are in electrical communication with switches 491, 492, 493, 494 on the switch plate 470, and in further electrical communication with memory segments internal to the IC 480. IC 480 power inputs VDD 485 and VDD1 486 are in electrical communication with the positive pole of the battery assembly 105. IC 480 power inputs GND 488 and GND1 489 are in electrical communication with the negative or ground pole of the battery assembly 105. Input OSC 487 is in electrical communication with an oscillator circuit internal to the IC 480. A resistor RI is connected to input 487 to determine the oscillation frequency of the oscillator circuit so that the IC 480 functions properly. In the present embodiment, a 330 kilo-ohm (K) resistor has been selected for RI.

FIG. 14 is an illustration showing major electrical components of an alternative embodiment of holder 300 having record and play functions or modes. In addition to components illustrated in FIG. 13, this embodiment includes a slide switch 500 connected to the control board 475 for selecting between a first mode and a second mode, in the present embodiment, a record mode and play mode, respectively. The slide switch 500 has a first position for selecting the first mode and a second position for selecting the second mode. A third position of the switch 500 may be included to provide a third mode in which electrical current is disconnected from the circuit, i.e. an off mode.

A microphone 505 is connected to the control board 475 for receiving sound waves to be recorded and for generating corresponding electrical signals that are stored in control board 475 memory. The microphone 505 is activated by sliding the slide switch 500 to a position corresponding to the record mode. When switch 500 is placed in record mode, pressing button 360 initiates recording through microphone 505. When switch 500 is placed in play mode, pressing button 360 will initiate play back of the last recorded message through the speaker 25.

FIG. 15 is a diagrammatical schematic of the electrical components of FIG. 14 including a battery power source 105 (three button cell batteries delivering approximately 4.5V, 70 mA), an integrated circuit (IC) 520 including a memory chip for storing and accessing audio recordings, a button 360 for engaging a switch plate 470 thereby forming a switching mechanism for initiating playback of audio stored in the IC 520 through a speaker 25, and a mode selection switch 500 for selecting between activation of IC 520 playback and record modes. When the mode selection switch 500 is placed in playback mode and button 360 is activated (e.g. pushed), electrical audio signals are transmitted from a memory storage segment within the IC 520 to speaker output terminals 530 and 532 and then to the speaker 25. The speaker 25 converts the electrical signals to audible sound waves. IC terminal REC 534 is activated when switch 500 is placed in record mode and button 360 is activated. IC terminal PLAYE 536 is activated when switch 500 is placed in playback mode and button 360 is activated. Upon activation of terminal 534, recording begins and audio is recorded through the microphone 505 and stored electronically in the IC 520. The microphone receives electrical power through IC terminals 538 and 540. Electrical power is provided to the IC 520 through positive terminals 550 and negative terminals 560. ROSC 570 is a terminal in electrical communication with the oscillator circuit within the IC 520.

The gift card holder 1, in any of the disclosed embodiments, is typically sold secured within packaging including clear wrap, a cardboard backing board and a hang tag or label. The holder 1 may be sold with the gift card 20 pre-installed within the slot 40 but more typically would be sold separately from the gift card 20 so that a holder 1 could be used with any commonly sized gift card 20.

It is to be understood that while certain forms of this invention have been illustrated and described, it is not limited thereto. For example, it is foreseen that the holder 1 may be constructed with housing 5, 10 and central opening 15 configurations other than rectangular, and that the slot 40 may be provided in other locations on the holder such as in the top or bottom side of the holder 1. The speaker 25 may comprise any appropriately constructed electromechanical transducer that converts an electrical signal into sound. The speaker 25 typically comprises a structure adapted for generating sound waves in accordance with a recorded audio segment, such as an acoustic speaker, piezoelectric buzzer, or equivalent device. The microphone 505 may comprise any of the following microphone types including condenser or capacitor microphone, electret condenser microphone, dynamic microphone, carbon microphone, or piezoelectric microphone. In addition, a conventional speaker, constructed much like a dynamic microphone with a diaphragm, coil and magnet, may be used both as a speaker 25 for the holder 1 and as a microphone for recording sound. It is further foreseen that the holder 1 may be constructed omitting the sound playback and recording features, including associated circuitry, so that its primary function is to serve as a decorative gift card display device and holder.

Having thus described the invention, what is claimed as new and desired to be secured by Letters Patent is:

1. A card holder comprising:
a frame having relatively wide, planar front and back surfaces and relatively narrow side edges, said frame including a generally central opening therethrough,
a slot formed in one of said side edges, said slot in communication with said central opening, said slot adapted to receive a card and allow conveyance of said card through said slot into said central opening,
means for securing said card within said opening,
said frame substantially enclosing circuitry for storing electrical signals corresponding to one or more sound recordings,
said circuitry including means for converting said electrical signals to sound waves,
means for initiating playback of said sound recording, and
an electrical power source for providing electrical power to said circuitry.

2. The card holder of claim 1, wherein said frame bears decorative images.

3. The card holder of claim 1, wherein said circuitry includes digital memory for storing said sound recording.

4. The card holder of claim 1, wherein said means for converting comprises an acoustic speaker.

5. The card holder of claim 1, wherein said means for converting comprises a piezoelectric buzzer.

6. The card holder of claim 1, wherein said means for initiating playback comprises a button housed within said frame and connected to said circuitry, said button adapted to initiate playback of said sound recording when pressed.

7. The card holder of claim 1, further comprising means for selecting between a record mode and a playback mode, wherein said playback mode energizes said circuitry to play a sound recording and said record mode energizes said circuitry to record sound.

8. The card holder of claim 7, wherein said means for selecting comprises a switch connected to said circuitry.

9. The card holder of claim 7, wherein said means for selecting comprises said means for initiating.

10. The card holder of claim 1, further comprising a microphone connected to said circuitry for recording sound.

11. The card holder of claim 1, further comprising means for user selection among a plurality of pre-recorded audio segments.

12. The card holder of claim 1, wherein said card comprises a gift card bearing unique indicia.

13. The card holder of claim 1, wherein said card comprises a gift card bearing magnetically recorded information.

14. The card holder of claim 1, wherein said sound recording comprises a voice recording.

15. The card holder of claim 1, wherein said sound recording comprises pre-recorded music.

16. A card holder comprising:
a frame having a plurality of sides enclosing an interior space,
a first opening in a first side and a second opening in a second, opposing side,
a slot in a third side, said slot in communication with said interior space, said slot sized to receive an article and allow conveyance of said article to said interior space so that said article is viewable through either opening when disposed within said interior space,
recording means for storing one or more audio segments, and
playback means for converting a stored audio segment to sound waves.

17. The card holder of claim 16, wherein said recording means and said playback means are user initiated through user activation of a switch.

18. A card holder comprising:
a relatively planar front housing attached to a similarly-sized, relatively planar, back housing to enclose an interior space and form relatively narrow sides,
an opening in said front housing in communication with said interior space,
a slot in one of said sides, said slot sized to allow passage of a relatively planar article into said interior space for viewing through said opening,
a user-activated record circuit for recording one or more audio segments,
a user-activated play circuit for playing one or more of said audio segments,
means for selecting between a recording mode, wherein sound is electronically stored within said card as said audio segment, and a playing mode, wherein said audio segment is electronically retrieved and used to generate sound, and
means for activating said record circuit or said play circuit in accordance with said means for selecting.

19. The card holder of claim 18, wherein said means for selecting comprises a slide switch having a first position for selecting a first mode, and a second position for selecting a second mode.

20. The card holder of claim 19, wherein said means for activating comprises a pressure sensitive button mounted on the housing.
